(19) United States
(12) Patent Application Publication
(10) Pub. No.: US 2007/0207368 A1
(43) Pub. Date: Sep. 6, 2007

(54) Method and apparatus for electrochemical flow field member

(76) Inventors: Everett Bragg Anderson, Glastonbury, CT (US); Tony J. Hurtado, Wallingford, CT (US); David Earl Henderson, Guilford, CT (US)

Correspondence Address: CANTOR COLBURN LLP, 55 Griffin Road South, Bloomfield, CT, 06002, US

(21) Appl. No.: 11/367,120

(22) Filed: Mar. 3, 2006

(51) Int. Cl. H01M 8/02; H01M 8/10; B05D 5/12; B32B 37/00

(52) U.S. Cl. 429/38; 429/32; 427/115; 156/280

(57) ABSTRACT

A bonded flow field member for an electrochemical cell is disclosed. The member comprises a first layer and a second layer, each having a plurality of through-holes. The first layer is diffusion bonded to the second layer, thereby defining a bonded assembly. The bonded assembly includes interface surfaces that are bonded between the layers and plating that is absent at the interface surfaces.

### BACKGROUND OF THE INVENTION

The present disclosure relates generally to electrochemical cells, and particularly to electrochemical cells having a screen pack flow field member.

Electrochemical cells are energy conversion devices, usually classified as either electrolysis cells or fuel cells. A proton exchange membrane electrolysis cell can function as a hydrogen generator by electrolytically decomposing water to produce hydrogen and oxygen gas, and can function as a fuel cell by electrochemically reacting hydrogen with oxygen to generate electricity. Referring to FIG. 1, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exit cell 100, while protons 106 and water 110 migrate across a proton exchange membrane 118 to cathode 114 where hydrogen gas 112 is formed.

Another typical water electrolysis cell using the same configuration as is shown in FIG. 1 is a cathode feed cell, wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

A typical fuel cell uses the same general configuration as is shown in FIG. 1. Hydrogen, from hydrogen gas, methanol, or other hydrogen source, is introduced to the hydrogen electrode (the anode in fuel cells), while oxygen, or an oxygen-containing gas such as air, is introduced to the oxygen electrode (the cathode in fuel cells). Water can also be introduced with the feed gas. Hydrogen electrochemically reacts at the anode to produce protons and electrons, wherein the electrons flow from the anode through an electrically connected external load, and the protons migrate through the membrane to the cathode. At the cathode, the protons and electrons react with oxygen to form water, which additionally includes any feed water that is dragged through the membrane to the cathode. The electrical potential across the anode and the cathode can be exploited to power an external load.

In other embodiments, one or more electrochemical cells can be used within a system to both electrolyze water to produce hydrogen and oxygen, and to produce electricity by converting hydrogen and oxygen back into water as needed. Such systems are commonly referred to as regenerative fuel cell systems.

Electrochemical cell systems typically include a number of individual cells arranged in a stack, with the working fluids directed through the cells via input and output conduits or ports formed within the stack structure. The cells within the stack are sequentially arranged, each including a cathode, a proton exchange membrane, and an anode. The cathode and anode may be separate layers or may be integrally arranged with the membrane. Each cathode/membrane/anode assembly (hereinafter “membrane-electrode-assembly”, or “MEA”) typically has a first flow field in fluid communication with the cathode and a second flow field in fluid communication with the anode. The MEA may furthermore be supported on both sides by screen packs or bipolar plates that are disposed within, or that alternatively define, the flow fields. Screen packs or bipolar plates may facilitate fluid movement to and from the MEA, membrane hydration, and may also provide mechanical support for the MEA.

In order to maintain intimate contact between cell components under a variety of operational conditions and over long time periods, uniform compression may be applied to the cell components. Pressure pads or other compression means are often employed to provide even compressive force from within the electrochemical cell.

To preserve conductivity between contacting surfaces without degradation from oxidation and corrosion, each part within a screen pack flow field member may be platinum plated. This may include each level of screen material within a screen pack that may be tack welded together. While existing internal components are suitable for their intended purposes, there still remains a need for improvement, particularly regarding cell efficiency at lower cost, weight and size. Accordingly, a need exists for improved internal cell components of an electrochemical cell, and particularly reduced cost manufacturing methods for screen pack flow fields members.

### BRIEF DESCRIPTION OF THE INVENTION

An embodiment of the invention includes a bonded flow field member for an electrochemical cell. The member comprises a first layer and a second layer, each having a plurality of through-holes. The first layer is diffusion bonded to the second layer, thereby defining a bonded assembly. The bonded assembly includes interface surfaces that are bonded between the layers and plating that is absent at the interface surfaces.

Another embodiment of the invention includes an electrochemical cell. The cell includes a first cell separator plate, a second cell separator plate, and a plurality of membrane-electrode-assemblies (MEAs), alternatively arranged with a plurality of flow field members between the first cell separator plate and the second cell separator plate. At least one of the flow field members includes a first layer and a second layer, each having a plurality of through-holes. The first layer is diffusion bonded to the second layer, thereby defining a bonded assembly. The bonded assembly includes interface surfaces that are bonded between the layers and plating that is absent at the interface surfaces.

Another embodiment of the invention includes a method of forming a flow field member for an electrochemical cell. The method includes providing a first layer and a second layer, each having a plurality of through-holes, and diffusion bonding the first layer to the second layer, thereby defining a bonded assembly, which has interface surfaces that are bonded between the layers. Subsequent to the diffusion bonding, the bonded assembly is plated such that the plating that is absent at the interface surfaces.

### BRIEF DESCRIPTION OF THE DRAWINGS

Referring to the exemplary drawings wherein like elements are numbered alike in the accompanying Figures:

FIG. 1 depicts a schematic diagram of a partial electrochemical cell showing an electrochemical reaction for use in accordance with embodiments of the invention;

FIG. 2 depicts a schematic diagram of an electrochemical cell system for use in accordance with embodiments of the invention;

FIG. 3 depicts a schematic diagram of a partial electrochemical cell in accordance with embodiments of the invention;

FIG. 4 depicts an enlarged partial plan view of two screen plies of a flow field member in accordance with embodiments of the invention;

FIG. 5 depicts a cross section view of the screen plies of the flow field member in FIG. 4 in accordance with embodiments of the invention; and

FIGS. 6A and 6B depict enlarged partial cross section views of an interface region between two screen plies in accordance with embodiments of the invention.

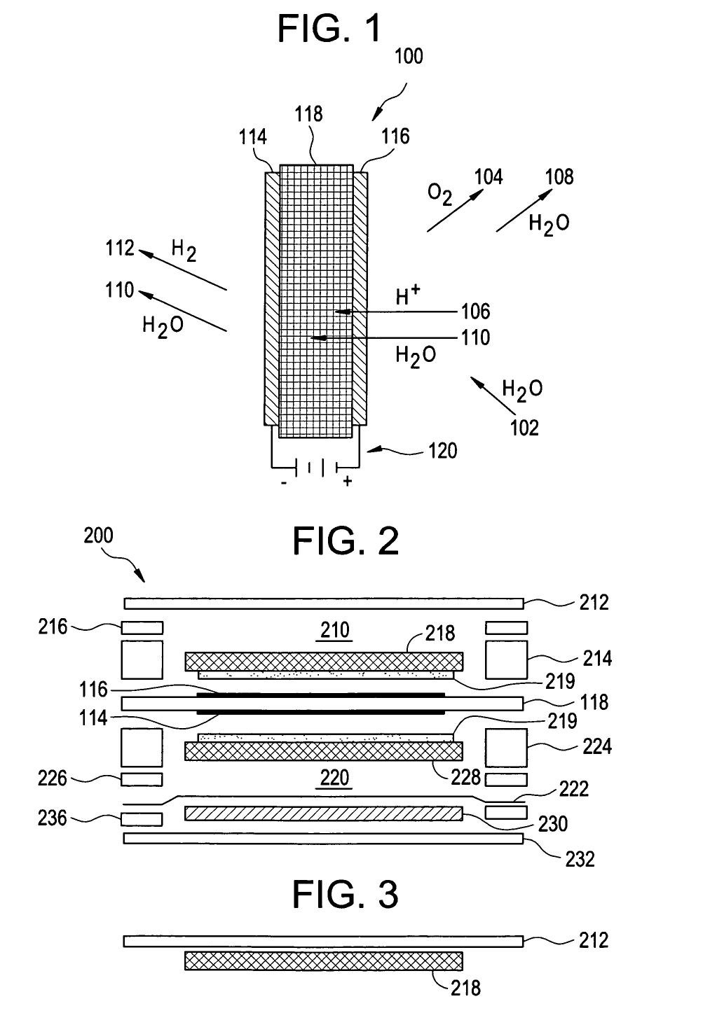

### DETAILED DESCRIPTION OF THE INVENTION

Exemplary embodiments of the invention provide a diffusion bonded flow field member made of platinum plated titanium screen packs and platinum plated conductive porous media (CPM), also herein referred to as porous plate. While embodiments disclosed herein describe titanium as an exemplary screen material, it will be appreciated that the disclosed invention may also be applicable to screens made from other materials such as zirconium, for example. Also, while embodiments disclosed herein describe plating with platinum, it will be appreciated that the disclosed invention may also be applicable to alternate coating materials and methods such as titanium nitriding, for example.

Referring to FIG. 2, an electrochemical cell system 200 that may be suitable for operation as an anode feed electrolysis cell, cathode feed electrolysis cell, fuel cell, or regenerative fuel cell, is depicted schematically in an exploded cross section view. Thus, while the discussion below may be directed to an anode feed electrolysis cell, cathode feed electrolysis cells, fuel cells, and regenerative fuel cells are also contemplated. Cell 200 is typically one of a plurality of cells employed in a cell stack as part of an electrochemical cell system. When cell 200 is used as an electrolysis cell, power inputs are generally between about 1.48 volts and about 3.0 volts, with current densities between about 50 A/ft² (amperes per square foot) and about 4,000 A/ft². When used as a fuel cell, power outputs range between about 0.4 volts and about 1 volt, and between about 0.1 A/ft² and about 10,000 A/ft². The number of cells within the stack, and the dimensions of the individual cells is scalable to the cell power output and/or gas output requirements. Accordingly, application of electrochemical cell 200 may involve a plurality of cells 200 arranged electrically either in series or parallel depending on the application. Cells 200 may be operated at a variety of pressures, such as up to or exceeding 50 psi (pounds-per-square-inch), up to or exceeding about 100 psi, up to or exceeding about 500 psi, up to or exceeding about 2500 psi, or even up to or exceeding about 10,000 psi, for example.

In an embodiment, cell 200 includes a membrane 118 having a first electrode (e.g., an anode) 116 and a second electrode (e.g., a cathode) 114 disposed on opposite sides thereof. Flow fields 210, 220, which are in fluid communication with electrodes 116 and 114, respectively, are defined generally by the regions proximate to, and bounded on at least one side by, each electrode 116 and 114 respectively. A flow field member (also herein referred to as a screen pack) 228 may be disposed within flow field 220 between electrode 114 and, optionally, a pressure pad separator plate 222. A pressure pad 230 is typically disposed between pressure pad separator plate 222 and a cell separator plate 232. Cell separator plate 232 is disposed adjacent to pressure pad 230. A frame 224, generally surrounding flow field 220 and an optional gasket 226, is disposed between frame 224 and pressure pad separator plate 222 generally for enhancing the seal within the reaction chamber defined on one side of cell system 200 by frame 224, pressure pad separator plate 222 and electrode 114. Gasket 236 may be disposed between pressure pad separator plate 222 and cell separator plate 232 enclosing pressure pad 230.

Another screen pack 218 may be disposed in flow field 210. Optionally, screen packs 218, 228 may include a porous plate 219 as depicted. The porous plate 219 shall preferably be of conductive material, and may be included to provide additional mechanical support to the electrodes 116, 114. A frame 214 generally surrounds screen pack 218. A cell separator plate 212 is disposed adjacent screen pack 218 opposite oxygen electrode 116, and a gasket 216 may be disposed between frame 214 and cell separator plate 212, generally for enhancing the seal within the reaction chamber defined by frame 214, cell separator plate 212 and the oxygen side of membrane 118. The cell components, particularly cell separator plates 212, 232, frames 214, 224, and gaskets 216, 226, and 236 are formed with the suitable manifolds or other conduits as is conventional.

In an embodiment, membrane 118 comprises electrolytes that are preferably solids or gels under the operating conditions of the electrochemical cell. Useful materials include proton conducting ionomers and ion exchange resins. Useful proton conducting ionomers include complexes comprising an alkali metal salt, an alkali earth metal salt, a protonic acid, or a protonic acid salt. Useful complex-forming reagents include alkali metal salts, alkaline metal earth salts, and protonic acids and protonic acid salts. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt is complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins may include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is NAFION™ resins (commercially available from E.I. du Pont de Nemours and Company, Wilmington, Del.).

Electrodes 116 and 114 may comprise a catalyst suitable for performing the needed electrochemical reaction (i.e., electrolyzing water and producing hydrogen). Suitable catalyst include, but are not limited to, materials comprising platinum, palladium, rhodium, carbon, gold, tantalum, tungsten, ruthenium, iridium, osmium, alloys thereof, and the like. Electrodes 116 and 114 may be formed on membrane 118, or may be layered adjacent to, but in contact with, membrane 118.

Screen packs 218, 228 support membrane 118, allow the passage of system fluids, and preferably are electrically conductive. The screen packs 218, 228 may include one or more layers of perforated sheets or a woven mesh formed from metal or strands.

Pressure pad 230 provides even compression between cell components, is electrically conductive, and therefore generally comprises a resilient member, preferably an elastomeric material, together with a conductive material. Pressure pad 230 is capable of maintaining intimate contact to cell components at cell pressures up to or exceeding about 100 psi, preferably about 500 psi, more preferably about 2,500 psi, or even more preferably about 10,000 psi. The pressure pads can thus be introduced into a high-pressure electrochemical cell environment.

In accordance with embodiments of the invention, diffusion bonding some or all of the components that comprise the flow field within a cell may require less precious metal and plating time, simplify assembly, and improve performance via reduced variation and lower electrical resistance.

Referring now to FIG. 4, an embodiment of two individual screen plies 300, 305 of an exemplary screen pack 218 are depicted. As used herein, reference numeral 218 may refer to either the screen pack 218 disposed within the Oxygen flow field 210 as depicted in FIG. 2, or may also refer to screen packs 218 in a general sense. It will be appreciated that while only two plies 300, 305 are depicted in FIG. 4 for illustration clarity, the scope of the invention is not so limited, and that it is contemplated to have additional screen plies within a screen pack. In the plan view of FIG. 4, ply 300 is depicted disposed on top of ply 305, and is the outer ply 300 of a screen pack 218 that may contain more than two plies. As used herein, reference number 299 will refer to a plurality of plies in general, while reference numerals 300 and 305 will refer to an outermost ply (also herein referred to as the first layer) 300, and a second ply (also herein referred to as the second layer) 305 in the screen pack 218. In an embodiment having three plies 299, the two outer plies would be represented by two plies 300, and the inner ply would be represented by ply 305 disposed therebetween. Within a dashed circle 310, an interface region 315 is shown where ply 300 may be in physical contact with ply 305.

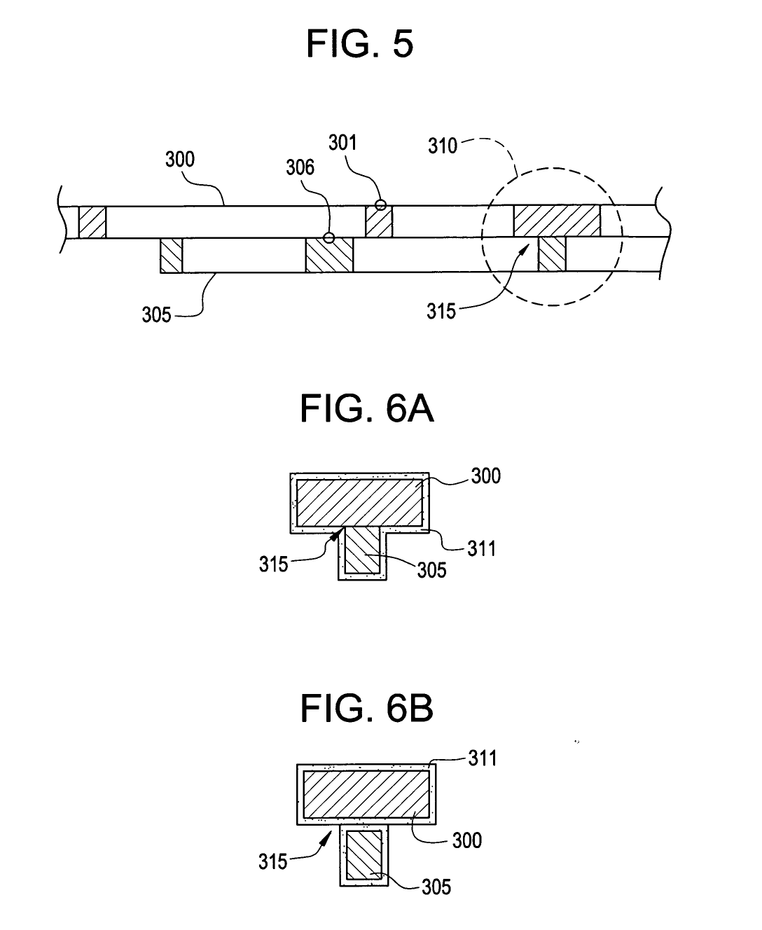

Referring now to FIG. 5, a cross section of an embodiment of the two plies 300, 305 is depicted. The dashed circle 310 indicates the exemplary interface region 315, wherein physical contact between the two plies 300, 305 may occur. In response to diffusion bonding, the plies 300, 305 become joined together at the interface region(s) 315. As a result of this joining of ply surfaces at the interface region 315, any surface treatments such as plating for example, applied subsequent to the diffusion bonding will not be applied to the surfaces within the interface region 315. Although only one interface region 315 has been described above and depicted in FIG. 5, it will be appreciated that each point of contact between the adjacent plies 299 will define an interface region 315.

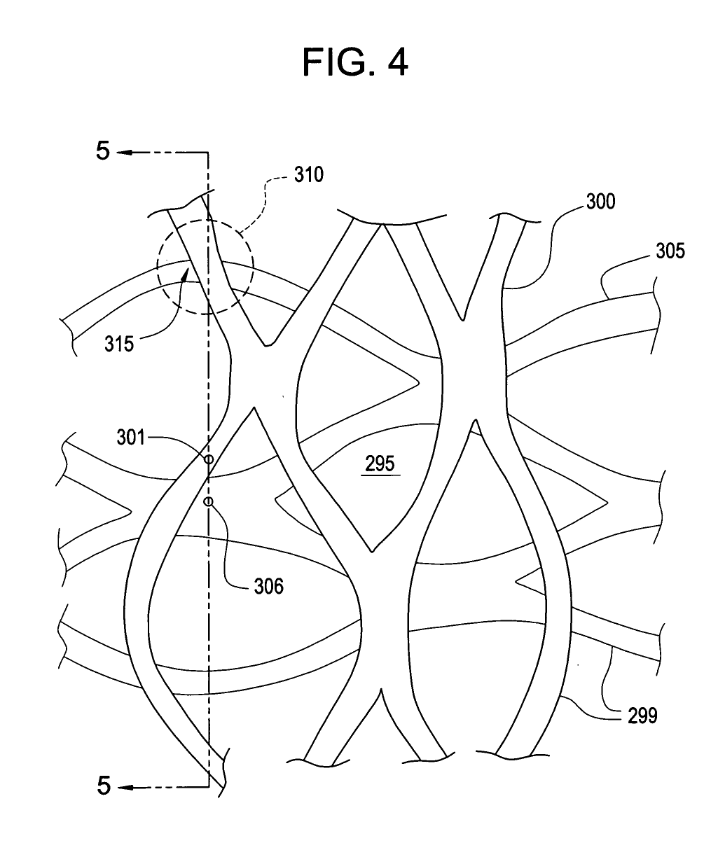

In an embodiment, a 0.1 square foot screen pack 218 may be made from several plies 299, such as seven for example, of 0.010 inch thick titanium screen with a plurality of through holes 295, which may include elongated openings oriented at 90 degrees to the touching screen ply 299, such as depicted in FIG. 4. These plies 299 may be diffusion bonded into a single, unitized screen pack 218. In an alternate embodiment, a layer of porous plate 219 may also be diffusion bonded to the plies 299 to create the screen pack 218, as may be seen by reference to FIG. 2. In yet another embodiment, the screen pack 218 may be diffusion bonded to the cell separator plate 212, as illustrated in FIG. 3. Following diffusion bonding, each screen pack 218 may be platinum plated via a process known in the art.

While an exemplary embodiment of the screen pack 218 may be described comprising titanium screen plies, it will be appreciated that the scope of the invention is not so limited, and that the invention also applies to screen packs comprising other materials, such as niobium, zirconium, tantalum, titanium, carbon steel, stainless steel, nickel, cobalt, and alloys thereof, and may alternatively be arranged as aforementioned perforated sheet or woven mesh, for example. Additionally, although the exemplary embodiment of the screen pack 218 may be described as platinum plated, it will be appreciated that the scope of the invention is not so limited, and that the invention may also apply to alternate coatings and surface treatments, such as titanium nitriding, for example.

In an embodiment, with reference to FIGS. 4 and 5, exemplary plating thickness measurements, taken from the outer layer (ply) 300 toward the center layer of the screen pack 218, indicate that a thicker layer of plating may be deposited upon the outermost ply 300. For example, in an embodiment, measurements taken on the outermost ply 300, at locations such as indicated by reference numeral 301 for example, have shown that plating thicknesses range from about 10.7 micro-inches (μ-in) to about 13.5μ-in. Measurements taken on ply 305 (the second layer from the outside) at locations such as indicated by reference numeral 306 for example, have shown that plating thicknesses range from about 2.06μ-in to about 3.8μ-in. As used herein, the term “about” represents a minimum deviation resulting from typical material, process, and measurement tolerances.

In an embodiment of the invention, the absence of plating at the interface regions 315 and the reduced plating thicknesses of the inner plies 299 disposed within the screen pack 218, provide a net reduction in the total plating material used. The reduced consumption of plating materials therefore reduces the cost of screen pack 218 manufacture.

Referring now to FIGS. 6A and 6B, enlarged cross section views of the interface region 315 within the dashed circle 310 depicted in FIG. 5 are depicted. FIG. 6A depicts a representation of two screen plies 300, 305 that have been diffusion bonded prior to plating in accordance with an embodiment of the invention. FIG. 6B depicts a representation of two screen plies 300, 305 that have been plated prior to bonding/assembly into a screen pack 218. It may be appreciated that the absence of plating 311 at the interface region 315 of the plies 300, 305 of FIG. 6A results in direct contact between ply 300 and ply 305. As a result, this direct contact between ply 300 and ply 305 is contemplated to provide a reduction in the overall electrical resistance of the screen pack 218.

In the exemplary embodiment of the screen pack 218 containing seven screen plies 299, the flow and pressure characteristics in response to plies 299 that have been diffusion bonded prior to plating may be measured and compared to screen packs 218 where the plies 299 have been tack welded subsequent to plating. Such flow for an exemplary embodiment of the screen pack 218 that has been fabricated via tack welding subsequent to the plating of each ply 299 has been measured to be about 8.5 to 9.0 milliliters per minute (mL/min) with no measurable pressure drop across the screen pack 218. An embodiment of the screen pack 218 with plies 299 that have been diffusion bonded prior to plating has been measured to have a flow rate of about 7 mL/min with no measurable pressure drop across the screen pack 218. As such, it is concluded that there is no appreciable difference between the flow rates of pre- and post-plated screen pack 218 arrangements.

Incorporation of an optionally bonded porous plate 219 may change the flow characteristics slightly. For example, flow for an embodiment of the screen pack 218 that has been fabricated via tack welding subsequent to the plating of each ply 299 disposed proximate to a porous plate 219 has been measured to be about 9.5 mL/min to 10 mL/min with a pressure drop of about 15 pounds per square inch (psi) across the screen pack 218. Comparatively, an embodiment of the screen pack 218 that has been fabricated via diffusion bonding of screen plies 299 prior to plating disposed proximate to a porous plate 219 has been measured to have a flow rate of about 8 mL/min with a pressure drop of about 14 psi across the screen pack 218. And further comparatively, an alternate embodiment of the screen pack 218, in which the plies 299 have been diffusion bonded with the porous plate 219 prior to plating, has been measured to have a flow rate of about 7.5 mL/min with a pressure drop of about 40 psi across the screen pack 218. As such, it is concluded that diffusion bonding the porous plate 219 to the screen pack 218 prior to plating may still be beneficial, but may have more limited applications.

In view of the foregoing discussion of structure, an exemplary method to manufacture a flow field member including an embodiment of the screen pack 218 will now be discussed with reference to FIGS. 3 and 4. As described above, each screen ply 299 (also herein referred to as a flow field member layer) of the screen pack 218 shall have the plurality of through-holes 295. In an embodiment, the through-holes 295 may have an orientation as depicted in FIG. 4. That is, it may be desirable to arrange the plies 299 to alternate or offset the through-hole 295 orientation between adjacent plies 299 by a 90 degree rotation, as depicted in FIG. 4, for example. Following the desired arrangement of plies 299, the plies 299 shall be diffusion bonded together into a bonded assembly. Subsequent to bonding, the bonded assembly shall receive a surface treatment, such as platinum plating for example, to prevent surface corrosion and oxidation within the electrochemical cell 200. Optionally, a porous plate 219 may be diffusion bonded with the screen plies 299 into the bonded assembly, and then subsequently plated. In yet another embodiment, the screen plies 299 may be diffusion bonded with a cell separator plate 212, and then subsequently plated.

While an embodiment of the invention has been described to offset through-hole orientation via a 90 degree ply rotation, it will be appreciated that the scope of the invention is not so limited, and that the invention also applies to alternate ply arrangements, such as varying amounts of relative rotation, or translation to offset the through-hole centers, for example.

As disclosed, some embodiments of the invention may include some of the following advantages: lower screen pack manufacturing cost by reducing consumption of plating materials; simplifying cell assembly by unitizing individual screen plies into a bonded subassembly; and, reducing screen pack resistance by increasing interface area contact and eliminating a high-resistance plating interface, thereby increasing cell efficiency.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A bonded flow field member for an electrochemical cell, the member comprising:
a first layer having a plurality of through-holes;
a second layer having a plurality of through-holes;
the first layer being diffusion bonded to the second layer, thereby defining a bonded assembly comprising interface surfaces that are bonded between the layers; and
the bonded assembly comprising plating that is absent at the interface surfaces.

2. The member of claim 1, wherein:
the first layer and the second layer are layers within a set of layers comprising more than two layers, each layer comprising a plurality of through-holes; and
the set of layers are diffusion bonded together, thereby defining the bonded assembly comprising interface surfaces that are bonded between the respective layers, each of the bonded interface surfaces being absent plating.

3. The member of claim 2, wherein:
the more than two layers comprises outer layers and at least one inner layer disposed therebetween, the inner layer having a plating thickness that is less than that of the outer layers.

4. The member of claim 1, wherein:
the first and second layers are made from screen material.

5. The member of claim 1, wherein:
the first and second layers comprise Titanium; and
the plating comprises Platinum.

6. The member of claim 1, wherein:
the plating thickness of the first layer is greater than the second layer.

7. The member of claim 1, further comprising:
at least one of a porous plate and a cell separator plate, the at least one plate being diffusion bonded to the first layer at interface surfaces that are absent plating.

8. The member of claim 1, wherein:
the layers are arranged to offset alignment of the through-holes.

9. An electrochemical cell comprising:
a first cell separator plate and a second cell separator plate; and
a plurality of membrane-electrode-assemblies (MEAs) alternatively arranged with a plurality of flow field members between the first cell separator plate and the second cell separator plate;
wherein at least one of the plurality of flow field members comprises:
a first layer having a plurality of through-holes;
a second layer having a plurality of through-holes;
the first layer being diffusion bonded to the second layer, thereby defining a bonded assembly comprising interface surfaces that are bonded between the layers; and
the bonded assembly comprising plating that is absent at the interface surfaces.

10. The electrochemical cell of claim 9, wherein:
the first layer and the second layer are layers within a set of layers comprising more than two layers, each layer comprising a plurality of through-holes; and
the set of layers are diffusion bonded together, thereby defining the bonded assembly comprising interface surfaces that are bonded between the respective layers, each of the bonded interface surfaces being absent plating.

11. The electrochemical cell of claim 9, wherein:
the first and second layers are made from screen material.

12. The electrochemical cell of claim 9, wherein:
the first and second layers comprise Titanium;
the plating comprises Platinum; and
the plating thickness of the first layer is greater than the second layer.

13. The electrochemical cell of claim 9, further comprising:
at least one of a porous plate and the cell separator plate, the at least one plate being diffusion bonded to the first layer at interface surfaces that are absent plating.

14. The electrochemical cell of claim 9, wherein:
the layers are arranged to offset alignment of the through-holes.

15. A method of forming a flow field member for an electrochemical cell, the method comprising:
providing a first layer having a plurality of through-holes;
providing a second layer having a plurality of through-holes;
diffusion bonding the first layer to the second layer, thereby defining a bonded assembly comprising interface surfaces that are bonded between the layers;
subsequent to the diffusion bonding, plating the bonded assembly such that the bonded assembly comprises plating that is absent at the interface surfaces.

16. The method of claim 15, further comprising:
arranging the first layer relative to the second layer to offset through-hole alignment.

17. The method of claim 15, further comprising:
providing more than two layers, each layer having a plurality of through-holes.

18. The method of claim 15, wherein:
the diffusion bonding further comprises diffusion bonding the first layer to at least one of a porous plate or the cell separator plate at interface surfaces that are absent plating.

19. The method of claim 15, wherein:
the providing comprises layers that comprise Titanium screen material.

20. The method of claim 15, wherein:
the subsequent to the diffusion bonding, plating the bonded assembly comprises Platinum plating with thickness greater on the first layer than the second layer.
